(19) United States
(12) Patent Application Publication
(10) Pub. No.: US 2017/0091792 A1
(43) Pub. Date: Mar. 30, 2017

(54) METHODS AND APPARATUS FOR ESTIMATING POTENTIAL DEMAND AT A PROSPECTIVE MERCHANT LOCATION

(71) Applicant: MasterCard International Incorporated, Purchase, NY (US)

(72) Inventors: Ashutosh Kumar GUPTA, Varanasi (IN); Mayank PRAKASH, Dehradun (IN); Rohit MODI, New Delhi (IN)

(21) Appl. No.: 15/279,568

(22) Filed: Sep. 29, 2016

(30) Foreign Application Priority Data
Sep. 29, 2015 (SG) 10201508083X

(51) Int. Cl. G06Q 30/02

(52) U.S. Cl. CPC G06Q 30/0202; G06Q 30/0205

(57) ABSTRACT

A method for estimating potential demand at a prospective merchant location for a merchant of a prospective merchant industry is provided. The method includes receiving transaction data and determining from the transaction data a first set of transactions, which include transactions carried out by consumers with consumer origin locations within an area that includes the prospective merchant location. The method further includes determining from the first set of transactions a second set of transactions, which include transactions carried out at existing merchants in the prospective merchant industry, determining an existing merchant location for transactions in the second set of transactions, and estimating a distance travelled by a consumer from the consumer origin location to the existing merchant location The method also includes estimating the potential demand by using demand indication information for consumers, wherein the demand indication information for a consumer includes the distance travelled by the consumer.

### CROSS REFERENCE TO RELATED APPLICATIONS

This application claims the benefit of Singapore Patent Application No. 10201508083X filed Sep. 29, 2015, which is hereby incorporated by reference in its entirety.

### BACKGROUND

The present disclosure relates to a method and system for processing data. In particular, it provides a method and system for estimating potential demand at a prospective merchant location.

Determining demand for a particular type of store at a prospective merchant location is difficult. Merchants such as retailers or service providers typically make decisions on where to open new stores based on market research and intelligence. However the number of prospective customers is unknown, as is the size and value of the opportunity presented by a potential new store.

### BRIEF DESCRIPTION

In general terms, the present disclosure proposes a method and apparatus for estimating the potential demand for a new merchant at a prospective merchant location. In the proposed method and system, transaction data for customers of existing merchants is analyzed to determine customers located in an area including the prospective merchant location. The distances travelled to the existing merchants by these customers is then determined. The distances travelled to the existing merchants are used to estimate the demand at the prospective merchant location.

Demand in a location which is not being fulfilled from merchants close to that location can be estimated using the methods and systems described herein. An example application is as follows: if a large number of consumers from a particular location, for example a specific zip code, often travel 30 miles for Chinese food this gives an indication that there is demand in that location for a Chinese restaurant which is not being fulfilled. Therefore, using the results of the analysis, a recommendation to merchants to consider opening a Chinese restaurant close to that particular zip code can be made.

Stores which are opened in areas where there is a high demand which is not being fulfilled by a merchant in that area are likely to have a high chance of success if opened in the area because people had to travel large distances to obtain the product/service.

According to a first aspect, a computer-implemented method for estimating potential demand at a prospective merchant location for a merchant of a prospective merchant industry is provided. The method includes receiving transaction data including indications of transactions, determining a first set of transactions from the transaction data, the first set of transactions including transactions carried out by consumers having consumer origin locations within an area that includes the prospective merchant location, determining a second set of transactions from the first set of transactions, the second set of transactions including transactions carried out at existing merchants in the prospective merchant industry, for transactions in the second set of transactions, determining an existing merchant location, for transactions in the second set of transactions, estimating a distance travelled by a consumer from the consumer origin location and the existing merchant location, and estimating the potential demand at the prospective merchant location for a merchant of the prospective merchant industry using demand indication information for a plurality of consumers, wherein the demand indication information for a consumer includes the distance travelled by the consumer.

The method allows the potential demand for a prospective merchant to be estimated by analyzing the distances travelled by consumers to existing merchants in the same industry as the prospective merchant.

In an embodiment the method further includes receiving purchase data indicating purchases of products and/or services in at least one of the existing merchant locations; and matching purchases from the purchase data with transactions of the second set of transactions to obtain matched transaction purchase data, wherein the demand indication information for a consumer further includes an indication of the products and/or services purchased by the consumer.

By matching purchase data with the transaction data, the products and/or services purchased by consumers can be identified. This allows the products and/or services purchased to be included in the demand estimation.

In an embodiment the purchase data includes a transaction time and date indicator for each purchase and the transaction data includes a transaction time and data indicator, wherein matching purchases from the purchase data with transactions of the second set of transactions includes merging the purchase data and the transaction data on the basis of the transaction time and data indicator.

The purchase data may further include a total transaction amount indicator and the transaction data may further include a total transaction amount indicator. Thus matching purchases from the purchase data with transactions of the second set of transactions includes merging the purchase data and the transaction data on the basis of the transaction time and data indicator and the total transaction amount indicator.

In an embodiment the transaction data further includes a total transaction amount, wherein the demand indication information for a consumer further includes the total transaction amount. This allows the total spend of consumers to be incorporated in the demand estimation.

In an embodiment, the method further includes identifying repeat transactions by a consumer and wherein the demand indication information for a consumer further includes an indication the repeat transactions.

In an embodiment, the method further includes determining the consumer origin locations associated with the consumers.

In an embodiment, determining the consumer origin locations includes analyzing the locations of transactions in the transaction data and determining the consumer origin locations from the locations of the transactions.

In an embodiment, determining the consumer origin locations includes determining a home address for consumers from a database.

According to a second aspect, an apparatus for estimating potential demand at a prospective merchant location for a merchant of a prospective merchant industry is provided. The apparatus includes a computer processor and a data storage device, the data storage device having a transaction data segmentation component, a distance calculation component, and a demand estimation component including non-transitory instructions that, when executed, cause the processor to: receive transaction data including indications of transactions, determine a first set of transactions from the transaction data, the first set of transactions including transactions carried out by consumers having consumer origin locations within an area including the prospective merchant location, determine a second set of transactions from the first set of transactions, the second set of transactions including transactions carried out at existing merchants in the prospective merchant industry, for transactions in the second set of transactions, determine an existing merchant location, for transactions in the second set of transactions, estimate a distance travelled by a consumer from the consumer origin location and the existing merchant location, and estimate the potential demand at the prospective merchant location for a merchant of the prospective merchant industry using demand indication information for a plurality of consumers, wherein the demand indication information for a consumer includes the distance travelled by the consumer.

According to a third aspect, a non-transitory computer-readable medium is provided. The computer-readable medium has stored thereon program instructions for causing at least one processor to perform operations of a method disclosed above.

### BRIEF DESCRIPTION OF THE DRAWINGS

Embodiments of the disclosure will now be described for the sake of non-limiting example only, with reference to the following drawings in which:

FIG. 1 schematically illustrates a prospective merchant location, existing merchant locations and the locations of consumers which are analyzed to estimate potential demand at the prospective merchant location;

FIG. 2 is a block diagram of a data processing system according to an embodiment of the present disclosure;

FIG. 3 is a block diagram illustrating a technical architecture of the apparatus according to an embodiment of the present disclosure;

FIG. 4 is a flowchart illustrating a method of estimating potential demand at a prospective merchant location according to an embodiment of the present disclosure; and

FIG. 5 is a table showing purchase data used in an embodiment of the present disclosure.

### DETAILED DESCRIPTION

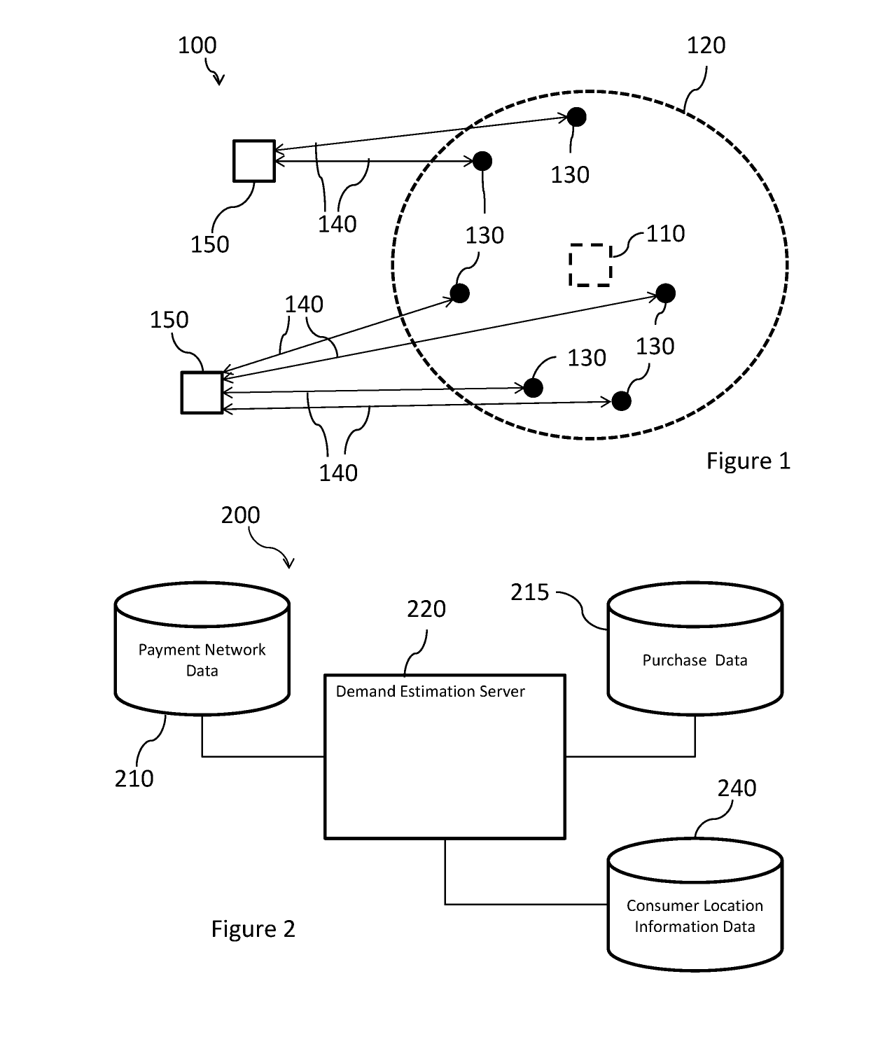

FIG. 1 shows a prospective merchant location 110 for which the potential demand is estimated in embodiments of the present disclosure. The prospective merchant location 110 is located within an area 120. The behavior of consumers 130 who are located within the area 120 is analyzed to assess the potential demand for a merchant at the prospective merchant location 110. As shown in FIG. 1, the consumers 130 travel distances 140 to visit existing merchants 150. Embodiments relate to estimating potential demand for a merchant in a prospective merchant industry at the prospective merchant location 110. In particular, the demand which is not being met by merchants in the area 120 is estimated in embodiments of the present disclosure.

As described in more detail below, in embodiments, consumers 130 within the area 120 who visit existing merchants 150 in the prospective merchant industry are identified. The distances 140 that the consumers 130 travel to the existing merchants 150 are used in the estimation of potential demand for a merchant in the prospective merchant industry at the prospective merchant location 110. In addition to the distances 140 travelled, the amount spent by the consumers 130 and the details of the products and/or services that are purchased may also be taken into account when estimating potential demand for at the prospective merchant location 110.

The existing merchants 150 may be retailers, restaurants, or other service providers. Each of the existing merchants 150 is connected to a payment network which processes payment card transactions. The payment network can be any electronic payment network which connects, directly and/or indirectly payers (consumers and/or their banks or similar financial institutions) with payees (the merchants and/or their banks or similar financial institutions). Non-limiting examples of the payment network are a payment card type of network such as the payment processing network operated by MasterCard, Inc. The various communication may take place via any types of network, for example, virtual private network (VPN), the Internet, a local area and/or wide area network (LAN and/or WAN), and so on.

The existing merchants may be connected to a purchase data network which records details of purchases made by customers. The purchase data network may be part of a loyalty card scheme implemented by merchants that records purchases on a stock keeping unit (SKU) level. An example of purchase data is the data provided by 5One Marketing Limited.

FIG. 2 shows a data processing system according to an embodiment of the present disclosure. The data processing system 200 includes a demand estimation server 220. The demand estimation server 220 is coupled to a payment network database which stores payment data 210, a purchase database which stores purchase data 215 and a consumer location information database which stores consumer location data 240.

The payment network data 210 includes transaction data indicating details of transactions carried out at merchants including the existing merchants 150 shown in FIG. 1. The purchase data 215 includes information on purchases carried out at merchants. It may include details of the goods and/or services purchased in transactions at merchants. The consumer location data 240 includes data which may be used to determine the locations, such as the home addresses of consumers. In one embodiment, the consumer location information data 240 may be address information stored in a bank customer database. In another embodiment, the consumer location information data 240 is data stored in a commercial marketing or consumer insight database. In another embodiment, the consumer location information data 240 is demographic data such as census data. An example of a database that provides the location of customers is Experian data which gives demographic data for countries such as the US. Census data can provide demographic information in places such as US, UK and Europe.

The payment network data 210, the purchase data 215 and the consumer location data 240 may all be resident on different servers. The servers may be either within a single data warehouse or distributed over a plurality of data warehouses. The data processed by the demand estimation server may be retrieved from the servers, and cleaned and stored in a data warehouse prior to the analyses being conducted. Alternatively, the demand estimation server 220 may receive the data from servers which may be operated by the different providers.

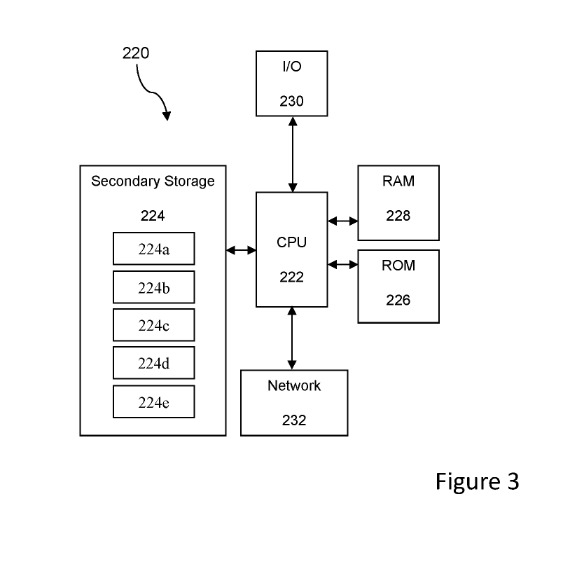

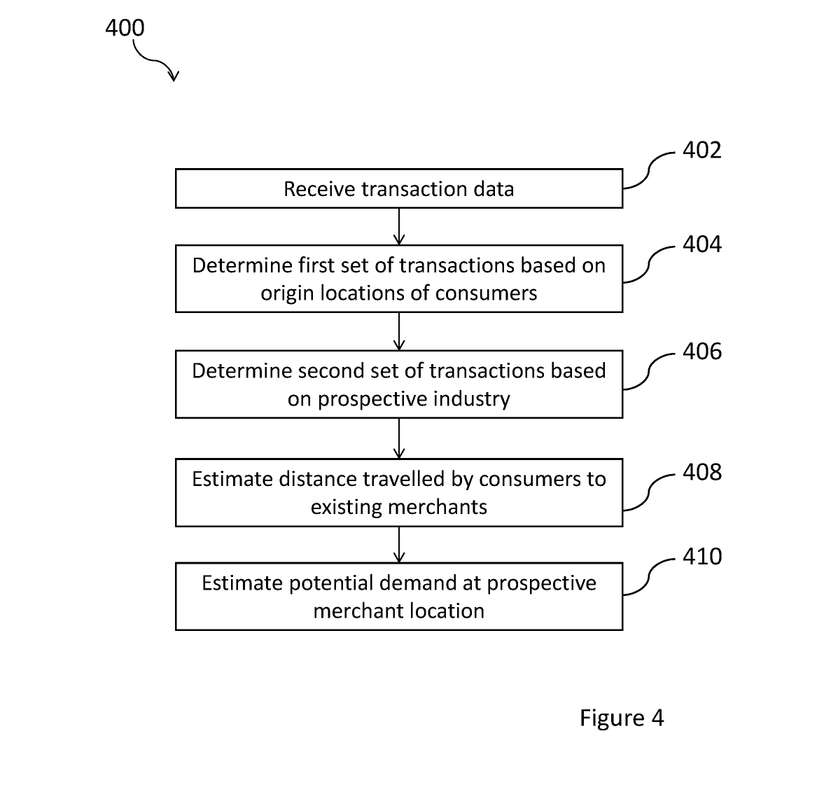

FIG. 3 is a block diagram showing a technical architecture of the server of the payment network data warehouse 150 for performing an exemplary method 400 which is described below with reference to FIG. 4. Typically, the method 400 is implemented by a computer having a data-processing unit. The block diagram as shown FIG. 3 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further include input/output (I/O) devices 230, and network connectivity devices 232.

The secondary storage 224 typically includes of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a consumer location component 224a, a transaction data segmentation component 224b, a matching component 224c, a distance calculation component 224d and an demand estimation component 224e including non-transitory instructions that, when executed, cause the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may provide computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 400 will now be described with reference to FIG. 4 in respect of analysis of transactions involving a merchant to provide key performance indicator and also an analysis of market data to provide relative market indicators. It should be noted that enumeration of operations is for purposes of clarity and that the operations need not be performed in the order implied by the enumeration.

In step 402, the demand estimation server 220 receives transaction data stored as payment network data 210 in the payment network database. The transaction data includes indications of transactions carried out using the payment network. The transaction data includes information such as the time and date of transactions, the transaction amount, an indication of merchant location and/or a merchant identifier, and an indication of the consumer such as a card number.

In step 404, the transaction data segmentation component 224b determines a first set of transactions from the transaction data received in step 402. The transactions in the first set of transactions are transactions carried out by consumers 130 located within the area 120. In step 404, the first set of transactions is determined from origin locations of the consumers. The origin locations are determined by the location component 224a.

The location component 224a may determine the origin locations of consumers in a number of different ways. In one embodiment, the location component 224a determines the origin locations by looking up address information corresponding to the consumers from the consumer location information data 240. In an alternative embodiment, the origin location component 224a may determine the origin location of consumers from an analysis of transactions made using the same payment card. The origin location may represent the home location of the consumers.

In step 406, the transaction data segmentation component 224b determines a second set of transactions from the first set of transactions. The second set of transactions are the transactions made by consumers 130 in the area 120 at existing merchants 150 which are in the prospective merchant industry. The payment network data 210 includes an indication of merchant industry. In step 406, the transaction data segmentation component 224b uses a merchant industry indicator in the transaction information to determine the merchant industry for transactions.

In step 408, distance calculation component 224d estimates the distance 140 travelled by the consumers 130 to the existing merchants 150. As discussed above, the origin or home location of the consumers 130 is determined by the location component 224a. The location of the existing merchants 150 determined from information stored by the payment network. Once both locations are known the distance travelled is estimated.

In step 410, the demand estimation component 224e estimates potential demand at the prospective merchant location 110. The demand estimation component 224e uses the distance travelled by consumers from the area 120 to the existing merchants 150 to estimate potential demand for a merchant in the prospective merchant industry at the prospective merchant location 110. For example, if a large number of consumers from the area 120 travel a large distance, for example more than 20km, to visit existing merchants 150, this is an indicator that there is high demand for a merchant in the prospective merchant industry at the prospective merchant location 110. In step 410, the demand estimation component 224e may also use an indication of transaction amount for transactions at the existing merchants to estimate potential demand at the prospective merchant location 110.

The demand estimated by the demand estimation component 224e in step 410 is the demand at the prospective merchant location 110 from consumers within the area 120 which is not being met by existing merchants close to the prospective merchant location 110.

In an embodiment, the matching component 224c matches transactions in the purchase data 215 with transactions in the second set of transactions determined in step 406. As described above, the purchase data 215 includes information on the products and/or services purchased in transactions. The information on the products and/or services purchased may then be included in the estimation of the potential demand carried out in step 410. This allows the demand for specific types of products and/or services to be determined in step 410. The matching carried out by the matching component 224c may involve matching transactions in the purchase data 215 with transactions in the second set of transactions using the time and date of the transactions. An identifier of the merchant and/or the total transaction amount may also be used in the matching process.

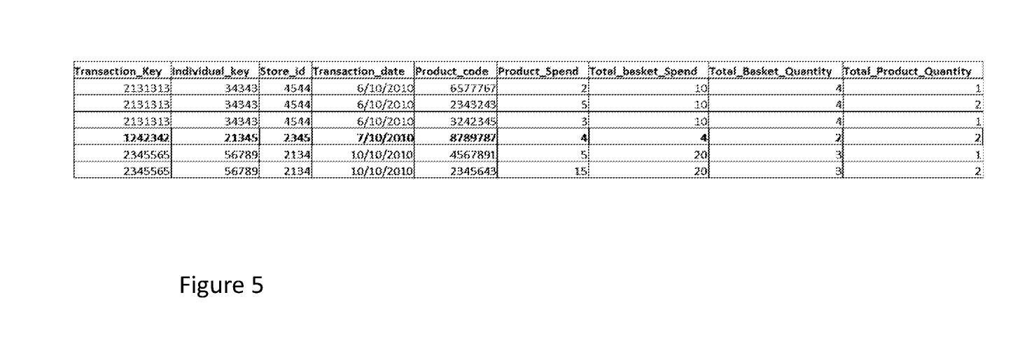

FIG. 5 shows an example of the purchase data 215 in an embodiment. As shown in FIG. 5, the purchase data 215 includes information that identifies the products and/or services purchased by a consumer. In the example shown in FIG. 5, the purchase data 215 has the following fields: Transaction_key; Individual_key; Store-id; Transaction Date; Product code; product_spend; Total_basket_spend; Total_basket_quantity; Total_product_quantity. Transaction_key is a unique identifier for each basket or transaction. Individual_key is a unique identifier for the customer making the purchase which may be determined from a loyalty card issued to the customer. When a customer enrolls for a loyalty card scheme, they receive a loyalty card which is identified with a unique key. Each time the customer visits the merchant and uses the loyalty card for a purchase the customer can therefore be uniquely identified. Store_id is a unique identifier of the merchant where the consumer is making the purchase. Transaction date is the date when the transaction happened. The purchase data 215 may also include transaction time information which may be used in the matching process as discussed above. Product code is the unique code for the product. Product spend is the spend on the product mentioned in the record. Total_basket spend is the total spend on all items in the basket. Total_basket_quantity is the total quantity of all the items in the basket. Total_product_quantity is the quantity of the product mentioned in the record.

As described above, embodiments of the present disclosure allow the market size and market value of an area to be estimated for a particular type of store or service provider. The number of customers can be estimated for a merchant of a particular industry. Further, by using the purchase data, the demand for particular types of goods and/or services within an industry can also be estimated. Further, by examining the changes over time, growth and future prospects for an industry or type of store can be estimated. Thus, embodiments of the present disclosure potentially provide merchants with accurate estimates of potential demand for prospective merchant locations.

Embodiments of the present disclosure may be used by merchants to determine the most beneficial locations for new premises. For example by repeating the method described above for a number of possible prospective merchant locations, a merchant is able to determine the location with the greatest potential demand. Further, once a decision has been made by a merchant to open a new store, the demand estimates may assist the merchant in determining the value of the prospective store or premise that they are going to open.

Further, estimations of the potential demand for a prospective merchant may assist in the valuation of the location in order to set a rental or lease amount for a premise or location.

Whilst the foregoing description has described exemplary embodiments, it will be understood by those skilled in the art that many variations of the embodiment can be made within the scope and spirit of the present disclosure.

1. A computer implemented method for estimating potential demand at a prospective merchant location for a merchant of a prospective merchant industry, the method comprising:
receiving, at a server, transaction data comprising indications of transactions;
determining, in a transaction data segmentation component of the server, a first set of transactions from the transaction data, the first set of transactions comprising transactions carried out by consumers having consumer origin locations within an area that includes the prospective merchant location;
determining, in the transaction data segmentation component of the server, a second set of transactions from the first set of transactions, the second set of transactions comprising transactions carried out at existing merchants in the prospective merchant industry;
determining an existing merchant location for transactions in the second set of transactions;
estimating, in a distance calculation component of the server, a distance travelled by a consumer from the consumer origin location and the existing merchant location for transactions in the second set of transactions; and
estimating, in a demand estimation component of the server, the potential demand at the prospective merchant location for a merchant of the prospective merchant industry using demand indication information for a plurality of consumers, wherein the demand indication information for a consumer comprises the distance travelled by the consumer.

2. A method according to claim 1, further comprising:
receiving purchase data indicating purchases of products and/or services in at least one of the existing merchant locations; and
matching, in a matching component of the server, purchases from the purchase data with transactions of the second set of transactions to obtain matched transaction purchase data, wherein the demand indication information for a consumer further comprises an indication of the products and/or services purchased by the consumer.

3. A method according to claim 2, wherein the purchase data comprises a transaction time and date indicator for each purchase and the transaction data comprises a transaction time and data indicator, and wherein matching purchases from the purchase data with transactions of the second set of transactions comprises merging the purchase data and the transaction data on the basis of the transaction time and data indicator.

4. A method according to claim 3, wherein the purchase data further comprises a total transaction amount indicator and the transaction data further comprises a total transaction amount indicator, and wherein matching purchases from the purchase data with transactions of the second set of transactions comprises merging the purchase data and the transaction data on the basis of the transaction time and data indicator and the total transaction amount indicator.

5. A method according to claim 1, wherein the transaction data further comprises a total transaction amount, and wherein the demand indication information for a consumer further comprises the total transaction amount.

6. A method according to claim 1 further comprising identifying repeat transactions by a consumer, wherein the demand indication information for a consumer further comprises an indication of the repeat transactions.

7. A method according to claim 1, further comprising determining, in a location component of the server, the consumer origin locations associated with the consumers.

8. A method according to claim 7, wherein determining the consumer origin locations comprises analyzing the locations of transactions in the transaction data and determining the consumer origin locations from the locations of the transactions.

9. A method according to claim 7, wherein determining the consumer origin locations comprises determining a home address for consumers from a database.

10. A non-transitory computer readable medium having stored thereon program instructions for causing at least one processor to perform a method according to claim 1.

11. An apparatus for estimating potential demand at a prospective merchant location for a merchant of a prospective merchant industry, the apparatus comprising:
a computer processor and a data storage device, the data storage device having a transaction data segmentation component, a distance calculation component, and a demand estimation component comprising non-transitory instructions by that, when executed, cause the processor to:
receive transaction data comprising indications of transactions;
determine a first set of transactions from the transaction data, the first set of transactions comprising transactions carried out by consumers having consumer origin locations within an area including the prospective merchant location;
determine a second set of transactions from the first set of transactions, the second set of transactions comprising transactions carried out at existing merchants in the prospective merchant industry;
determine an existing merchant location for transactions in the second set of transactions;
estimate a distance travelled by a consumer from the consumer origin location and the existing merchant location for transactions in the second set of transactions; and
estimate the potential demand at the prospective merchant location for a merchant of the prospective merchant industry using demand indication information for a plurality of consumers, wherein the demand indication information for a consumer comprises the distance travelled by the consumer.

12. An apparatus according to claim 11, wherein the data storage device further comprises a matching component comprising non-transitory instructions that, when executed, cause the processor to:
receive purchase data indicating purchases of products and/or services in at least one of the existing merchant locations; and
match purchases from the purchase data with transactions of the second set of transactions to obtain matched transaction purchase data, wherein the demand indication information for a consumer further comprises an indication of the products and/or services purchased by the consumer.

13. An apparatus according to claim 12, wherein the purchase data comprises a transaction time and date indicator for each purchase and the transaction data comprises a transaction time and data indicator, wherein the matching component further comprises non-transitory instructions that, when executed, cause the processor to match purchases from the purchase data with transactions of the second set of transactions by merging the purchase data and the transaction data on the basis of the transaction time and data indicator.

14. An apparatus according to claim 13, wherein the purchase data further comprises a total transaction amount indicator and the transaction data further comprises a total transaction amount indicator, wherein the matching component further comprises non-transitory instructions that, when executed, cause the processor to match purchases from the purchase data with transactions of the second set of transactions comprises merging the purchase data and the transaction data on the basis of the transaction time and data indicator and the total transaction amount indicator.

15. An apparatus according to claim 11, wherein the transaction data further comprises a total transaction amount, and wherein the demand indication information for a consumer further comprises the total transaction amount.

16. An apparatus according to claims 11, wherein the data storage device further comprises non-transitory instructions that, when executed, cause the processor to identify repeat transactions by a consumer and wherein the demand indication information for a consumer further comprises an indication the repeat transactions.

17. An apparatus according to claim 11, wherein the data storage device further comprises a location component comprising non-transitory instructions that, when executed, cause the processor to determine the consumer origin locations associated with the consumers.

18. An apparatus according to claim 17, wherein the location component comprises non-transitory instructions that, when executed, cause the processor to determine the consumer origin locations by analyzing the locations of transactions in the transaction data and determining the consumer origin locations from the locations of the transactions.

19. An apparatus according to claim 17, wherein the location component comprises non-transitory instructions that, when executed, cause the processor to determine the consumer origin locations by determining a home address for consumers from a database.
